(19) United States
(12) Patent Application Publication
(10) Pub. No.: US 2006/0210331 A1
(43) Pub. Date: Sep. 21, 2006

(54) Fixing device and image forming apparatus

(75) Inventors: Motofumi Baba, Kanagawa (JP); Yasuhiro Uehara, Kanagawa (JP); Yasushi Kawahata, Kanagawa (JP); Chikara Ando, Kanagawa (JP); Daisuke Yoshino, Kanagawa (JP); Toshiyuki Miyata, Kanagawa (JP)

Correspondence Address: MORGAN LEWIS & BOCKIUS LLP, 1111 PENNSYLVANIA AVENUE NW, WASHINGTON, DC, 20004, US

(73) Assignee: FUJI XEROX CO., LTD.

(21) Appl. No.: 11/212,596

(22) Filed: Aug. 29, 2005

(30) Foreign Application Priority Data
Mar. 16, 2005 (JP) P. 2005-074401

(51) Int. Cl. G03G 15/20

(52) U.S. Cl. 399/329

(57) ABSTRACT

A fixing device that fixes toner images carried on a recording material, including: a rotary member; a belt member that is brought into contact with the rotary member, wherein a nip part through which the recording material passes is formed between the belt member and the rotary member; and a roller member that stretches the belt member and presses the belt member against the rotary member, wherein the roller member includes an elastic layer, and a surface layer coated on a surface of the elastic layer, the surface layer being made of a material having a higher elastic modulus than that of the elastic layer.

### BACKGROUND OF THE INVENTION

1. Field of the Invention

The present invention relates to a fixing device, etc. for use in an image forming apparatus using electrophotographic mode or the like.

2. Background Art

Recently, in an image forming apparatus such as copy machines and printers, things using electrophotographic mode, electrostatic recording method, etc. become a main stream. In this image forming apparatus, if electrophotographic mode is used, the following image forming process can be used. Photosensitive drums having a drum shape are uniformly charged, and are then scan-exposed with light controlled on the basis of image information, thus forming electrostatic latent images on the photosensitive drums. Further, the electrostatic latent images are converted into visible images (toner images) by means of a toner. The toner images are directly transferred from the photosensitive drums to recording paper, or the toner images are primarily transferred to an intermediate transfer body and then secondarily transferred from the intermediate transfer body to recording paper, thereby forming the toner images on the recording paper. Thereafter, the toner images formed on the recording paper are fixed by means of the fixing device.

The fixing device used in this image forming apparatus includes a fixing roller in which a heat source is disposed within a cored bar having, e.g., a cylindrical shape, and a heat-resistant elastic layer and a peeling layer are laminated on the cored bar, and a pressing roller pressed against the fixing roller. In this case, the heat-resistant elastic layer and the peeling layer made of a heat-resistant resin coated layer or a heat-resistant rubber coated layer are laminated on the cored bar. Furthermore, the recording paper that carries non-fixed toner images thereon passes through the fixing roller and the pressing roller, and the non-fixed toner images are heated and pressed whereby the toner images are fixed on the recording paper. This fixing device is also referred to as “roller nip mode” and has been widely used.

In the fixing device of such roller nip mode, however, if speedup is to be attained, it is necessary to make wide a nip width in proportion to the fixing speed so as to supply a sufficient heat quantity to the toner and the recording paper. The method of widening the nip width can include a method of increasing load between the fixing roller and the pressing roller, a method of increasing a thickness of an elastic member, and a method of increasing the diameter of the elastic member.

In the method of increasing load or the method of increasing the thickness of the elastic member, the shape of the nip width becomes irregular along the roller axis due to bending of the roller. Therefore, there is a problem in the picture quality such as fixing spot or paper wrinkle. On the other hand, the method of increasing the diameter of the roller is also problematic in that the apparatus becomes bulky, and a warm-up time taken to raise a temperature of the roller from a room temperature to an available fixing temperature becomes long.

In view of this, in order to solve these problems and thus realize a fixing device corresponding to the speedup of the image forming apparatus, the present applicant proposes techniques related to a fixing device including a fixing roller having an elastic member coated thereon, and an endless belt stretched by a plurality of support rollers. In this case, the endless belt is pressed in such a way to surround only a predetermined angle of the fixing roller so that a nip region is formed between the endless belt and the fixing roller. Further, a pressing roller to which high pressure is locally applied than other portions of the nip region is disposed in the exit part (a lowest downstream portion) of the nip region (e.g., see Japanese Patent No. 3084692).

In the fixing device proposed in Japanese Patent No. 3084692, the endless belt in which several sheets of rollers are stretched is brought into contact with the fixing roller, thus forming a nip part (this is also referred to as “belt nip part”). By adopting this construction (this is also referred to as “belt nip mode”), the width of the belt nip part consisting of the fixing roller and the endless belt can become easily greater than that of the roller nip part between the fixing roller and the pressing roller in the prior art. It is thus possible to cope with the speedup and to miniaturize the apparatus.

In particular, in the fixing device of belt nip mode, heat transferred from the fixing roller is difficult to emit because heat capacity of the endless belt pressed against the fixing roller is low. Due to this, although the fixing roller begins rotating, heat quantity lost from the fixing roller to the endless belt is relatively small, and efficiency that heat is used to melt the toner is high. Accordingly, this method is advantageous in that the fixity of the toner can be improved.

In the fixing device of belt nip mode as proposed in Japanese Patent No. 3084692, however, the lowest downstream portion of the nip part having the fixing roller and the endless belt is constructed such that one of the rollers that stretch the endless belt (belt member) presses the fixing roller (fixing member) This causes the roller to serve as a pressing roller (pressing member) and also to locally apply high pressure to the lowest downstream portion of the nip part than other regions of the nip part. In this construction, since local pressing force is applied to toner images that are heated and melt in the nip part by means of the pressing roller, fixity in the toner images that have passed the nip part can be improved. Further, a proper glazing effect can be given to the toner image since a surface of a toner image before solidification can become smooth.

In this pressing roller, however, since sufficient local pressure is applied to the toner image, it is necessary to set so that the fixing roller is pressed in a region having a predetermined width. For this reason, an elastic layer is coated on a surface layer of the pressing roller, so that a predetermined width region is formed by means of the inclination of the elastic layer when being pressed. However, when recording paper of e.g., a small size passes through the region to which local pressure is applied by the pressing roller, there occurs a difference in a strain amount of the elastic layer of the pressing roller between a region through which the recording paper passes and a region through which the recording paper does not pass in a width direction of the pressing roller. For this reason, there is a difference in a surface velocity of the pressing roller between the region through which the recording paper passes and the region through which the recording paper does not pass. Accordingly, there is also a difference in a rotation speed in a width direction even in the endless belt stretched by the pressing roller. As a result, there is a problem in that strain of a wave shape or wrinkles in the rotation direction is easily generated in the endless belt. Furthermore, if strain of a wave shape or wrinkles is generated in the endless belt, there are problems in that fixity is degraded and the picture quality is lowered since adhesiveness between the fixing roller and the recording paper becomes low. There is also a problem in that the picture quality is significantly degraded in a solid image such as, especially, a photo image because lowering in a brilliance of a toner image results in a so-called glazing spot.

### SUMMARY OF THE INVENTION

The present invention has been made in view of the above problems.

An aspect of the present invention is a fixing device that fixes toner images carried on a recording material. The device includes a rotary member, a belt member that is brought into contact with the rotary member, wherein a nip part through which the recording material passes is formed between the belt member and the rotary member, and a roller member that stretches the belt member and presses the belt member against the rotary member. At this time, the roller member includes an elastic layer, and a surface layer coated on a surface of the elastic layer, the surface layer being made of a material having a higher elastic modulus than that of the elastic layer.

### BRIEF DESCRIPTION OF THE DRAWINGS

Embodiments of this invention will become more fully apparent from the following detailed description taken with the accompanying drawings in which:

FIG. 1 is a schematic construction showing an image forming apparatus according to the present invention;

FIG. 2 is a lateral sectional view showing the construction of a fixing device according to one embodiment of the present invention;

FIG. 3 is a sectional view showing the structure of the pressing roller;

FIG. 4 is a sectional view of the high-pressure nip part, which is viewed from an upper side of a conveying direction of paper;

FIG. 5 is a view showing distribution of the rotation speed in the width direction of the pressing belt;

FIG. 6 is a view showing the shape of the surface layer wherein a difference in the compression amount, which is generated in an elastic layer, is prohibited low;

FIG. 7 is a view showing the relation between the thickness of the surface layer and the surface strain ratio of the pressing roller;

FIG. 8 is a view showing a comparison result regarding generation of strain of a wave shape or wrinkles in the pressing belt when the surface layer is provided and not provided; and

FIG. 9 is a lateral sectional view showing the construction of the fixing device according to another embodiment of the present invention.

### DETAILED DESCRIPTION OF THE INVENTION

Hereinafter, the present invention will be described in detail in connection with embodiments according to the accompanying drawings.

Embodiment 1

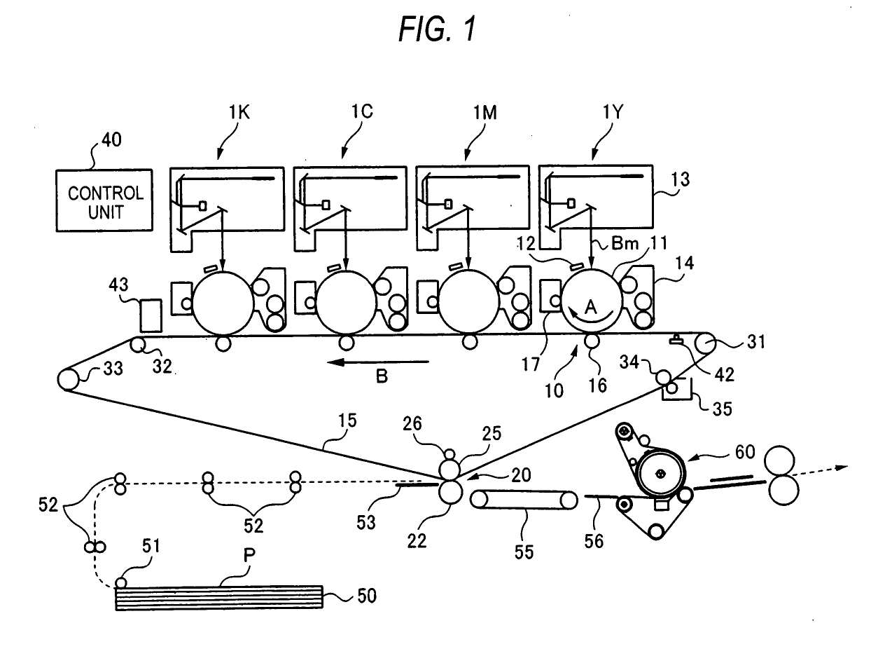

FIG. 1 is a schematic construction showing an image forming apparatus according to the present embodiment. The image forming apparatus shown in FIG. 1 is an image forming apparatus of intermediate transfer mode, which is generally referred to as “tandem type”. The image forming apparatus includes a plurality of image forming units 1Y, 1M, 1C and 1K on which color component toner images are respectively formed in electrophotographic mode, a primary transfer unit 10 that sequentially transfers (a primary transfer) the color component toner images respectively formed by the image forming units 1Y, 1M, 1C and 1K to an intermediate transfer belt 15, a secondary transfer unit 20 that batch-transfers (a secondary transfer) overlapping toner images transferred on the intermediate transfer belt 15 to paper P being a recording material (recording paper), and a fixing device 60 that fixes the images secondarily transferred on the paper P. The apparatus further includes a control unit 40 that controls the operation of each of the units (each part).

In the present embodiment, the image forming units 1Y, 1M, 1C and 1K have electrophotography devices sequentially disposed therein. The devices include a charging device 12 that charges photosensitive drums 11, a laser exposure device 13 (an exposure beam is indicated by reference numeral Bm in the drawing), which records electrostatic latent images on the photosensitive drums 11, a development device 14 that contains the color component toners and toner-images the electrostatic latent images on the photosensitive drums 11 using a toner, a primary transfer roller 16 that transfers each of the color component toner images formed on the photosensitive drums 11 to the intermediate transfer belt 15 using the primary transfer unit 10, and a drum cleaner 17 that removes the remaining toners on the photosensitive drums 11 around the photosensitive drums 11 that rotate in a direction of an arrow A. These image forming units 1Y, 1M, 1C and 1K are sequentially disposed approximately in straight-line form in order of yellow (Y), magenta (M), cyan (C) and black (K) from an upper stream side of the intermediate transfer belt 15.

The intermediate transfer belt 15 serving as an intermediate transfer body has an endless belt of a film shape, wherein an anti-charging agent, such as carbon black, is mixed in resin such as polyimide or polyamide. Furthermore, the intermediate transfer belt has a volume resistivity of 10⁶ to 10¹⁴ Ωcm and a thickness of about 0.1 mm. The intermediate transfer belt 15 is adapted to circulate (rotate) at a predetermined velocity in a direction of an arrow B shown in FIG. 1 by means of various rolls. The intermediate transfer belt 15 includes a driving roller 31, which is driven by a motor (not shown) having a good constant-velocity property and rotates the intermediate transfer belt 15, a support roller 32 that extends approximately in a straight line in a direction where the photosensitive drums 11 are arranged and supports the intermediate transfer belt 15, a tension roller 33 that applies predetermined tension to the intermediate transfer belt 15 and serves as a correction roller for preventing meandering of the intermediate transfer belt 15, a backup roller 25 disposed in the secondary transfer unit 20, and a cleaning backup roller 34 disposed in the cleaning part, for raking the remaining toners on the intermediate transfer belt 15.

The primary transfer unit 10 has a primary transfer roller 16 disposed opposite to each of the photosensitive drums 11 with the intermediate transfer belt 15 therebetween. The primary transfer roller 16 includes a shaft, and a sponge layer as an elastic member layer, which is fixed around the shaft. The shaft is a cylindrical pole made of iron, SUS or the like. The sponge layer is formed of blend rubber of NBR, SBR and EPDM in which a conductive agent such as carbon black is blended. The sponge layer has a volume resistivity of 10⁷ to 10⁹ Ωcm, and it is a cylindrical roller having a sponge shape. Further, the primary transfer roller 16 is disposed so that it is pressed against the photosensitive drums 11 with the intermediate transfer belt 15 therebetween. The primary transfer roller 16 is also applied with a voltage having an opposite polarity (a primary transfer bias) to a charging polarity (this is referred to as “minus polarity”) of the toner. Thus, the toner images on the photosensitive drums 11 are sequentially and electrostatically sucked on the intermediate transfer belt 15 whereby overlapping toner images are formed on the intermediate transfer belt 15.

The secondary transfer unit 20 includes a secondary transfer roller 22 and a backup roller 25 both of which are disposed on a toner image carrier surface side of the intermediate transfer belt 15. The backup roller 25 has a surface formed of blend rubber of EPDM and NBR in which carbon is dispersed, and an inside formed of EPDM rubber. Furthermore, the backup roller 25 has a surface resistivity of 10⁷ to 10¹⁰ Ω/square and hardness of e.g., 70° (C.). The backup roller 25 is disposed at the rear side of the intermediate transfer belt 15, and forms an opposite electrode to the secondary transfer roller 22. The back roller 25 is brought into contact with a feeding roller 26 made of metal to which secondary transfer bias is applied in a stable way.

On the other hand, the secondary transfer roller 22 includes a shaft, and a sponge layer as an elastic member layer fixed near the shaft. The shaft is a cylindrical pole made of iron, SUS or the like. The sponge layer is formed of blend rubber of NBR, SBR and EPDM in which a conductive agent such as carbon black is blended. The sponge layer has a volume resistivity of 10⁷ to 10⁹ Ωcm and is a cylindrical roller having a sponge shape. Furthermore, the secondary transfer roller 22 is disposed so that is pressed against the backup roller 25 with the intermediate transfer belt 15 therebetween. In addition, the secondary transfer roller 22 is grounded, so that a secondary transfer bias is formed between the secondary transfer roller 22 and the backup roller 25. The secondary transfer roller 22 functions to secondarily transfer the toner images on the paper P conveyed to the secondary transfer unit 20.

Furthermore, an intermediate transfer belt cleaner 35 for removing the remaining toners or paper powder on the intermediate transfer belt 15 and cleaning the surface of the intermediate transfer belt 15 after the secondary transfer is provided detachably on a downstream side of the secondary transfer unit 20 of the intermediate transfer belt 15. Meanwhile, a reference sensor (a home position sensor) 42 for generating a reference signal, which serves as a reference for an image forming timing in each of the image forming units 1Y, 1M, 1C and 1K, is disposed on an upstream side of the yellow image forming unit 1Y. An image concentration sensor 43 for controlling the picture quality is also disposed on a downstream side of the black image forming unit 1K. The reference sensor 42 recognizes a predetermined mark formed on a rear side of the intermediate transfer belt 15, and generates a reference signal based on the recognized mark. Each of the image forming units 1Y, 1M, 1C and 1K begins forming an image under the control of the control unit 40 based on the recognition of the reference signal.

Furthermore, in the image forming apparatus of the present embodiment, a paper conveying system includes a paper tray 50 for accommodating the paper P, a pickup roller 51 for picking up and conveying the paper P accommodated in the paper tray 50 at a predetermined timing, a conveying roller 52 for conveying the paper P output from the pickup roller 51, a conveying chute 53 for sending the paper P conveyed by the conveying roller 52 to the secondary transfer unit 20, a conveying belt 55 for conveying the paper P, which is secondarily transferred by the secondary transfer roller 22 and then conveyed, to the fixing device 60, and a fixing inlet guide 56 for guiding the paper P into the fixing device 60.

A basic image forming process of the image forming apparatus according to the present embodiment will now be described. In the image forming apparatus as shown in FIG. 1, image data output from an image read apparatus (IIT) (not shown), a personal computer (PC) (not shown) or the like undergo a predetermined image process through an image processing apparatus (IPS) (not shown), and then experience an image forming process through the image forming units 1Y, 1M, 1C and 1K. The IPS performs predetermined image processes such as shading correction, dislocation correction, brightness/color space conversion, gamma correction, frame removal, or various image editions such as color edition and motion edition on input reflexibility data. The image data on which the image processes are performed are converted into four-color material (Y, M, C and K) gray scale data, and then output to the laser exposure device 13.

In the laser exposure device 13, the exposure beam Bm output from a semiconductor laser, etc. is irradiated on the photosensitive drums 11 of the image forming units 1Y, 1M, 1C and 1K according to the received color material gray scale data.

In the photosensitive drums 11 of the image forming units 1Y, 1M, 1C and 1K, the surface of the photosensitive drums 11 is charged by means of the charging device 12, and is then scanned and exposed by means of the laser exposure device 13, thereby forming electrostatic latent images. The electrostatic latent images formed thus are developed as toner images of the colors Y, M, C and K by means of the image forming units 1Y, 1M, 1C and 1K, respectively.

The toner images formed on the photosensitive drums 11 of the image forming units 1Y, 1M, 1C and 1K are transferred on the intermediate transfer belt 15 in the primary transfer unit 10 in which the photosensitive drums 11 and the intermediate transfer belt 15 have a contact with each other.

To be more specific, in the primary transfer unit 10, the primary transfer roller 16 applies a voltage (a primary transfer bias) having an opposite polarity to a charging polarity (a minus polarity) of the toner to the base of the intermediate transfer belt 15. Accordingly, a primary transfer is carried out in such as manner that toner images are sequentially overlapped on the surface of the intermediate transfer belt 15.

After the toner images are sequentially primarily transferred on the surface of the intermediate transfer belt 15, the intermediate transfer belt 15 moves whereby the toner images are conveyed to the secondary transfer unit 20. If the toner images are conveyed to the secondary transfer unit 20, the pickup roller 51 rotates in the paper conveying system simultaneously when the toner images are conveyed to the secondary transfer unit 20. The paper P of a predetermined size is thus supplied from the paper tray 50. The paper P supplied from the pickup roller 51 is conveyed by the conveying roller 52, and then reaches the secondary transfer unit 20 via the conveying chute 53. Before the paper P reaches the secondary transfer unit 20, it is once stopped, and a resist roller (not shown) rotates at the timing when the intermediate transfer belt 15 that carries the toner images thereon moves. Thus, the position of the paper P and the position of the toner images are aligned together.

In the secondary transfer unit 20, the secondary transfer roller 22 is pressed against the backup roller 25 by means of the intermediate transfer belt 15. At this time, the paper P that is conveyed according to the timing is inserted between the intermediate transfer belt 15 and the secondary transfer roller 22. In this case, if a voltage (a secondary transfer bias) having the same polarity as a charging polarity (a negative polarity) of the toner is applied from the feeding roller 26, an electrostatic transfer electric field is formed between the secondary transfer roller 22 and the backup roller 25. Further, non-fixed toner images carried on the intermediate transfer belt 15 are batch-transferred on the paper P in the secondary transfer unit 20 that is pressed by means of the secondary transfer roller 22 and the backup roller 25.

Thereafter, the paper P on which the toner images are electrostatically transferred is conveyed by means of the secondary transfer roller 22 with it being peeled from the intermediate transfer belt 15. The paper is then conveyed to the conveying belt 55 disposed on a downstream side of a paper-conveying direction of the secondary transfer roller 22. In the conveying belt 55, the paper P is conveyed up to the fixing device 60 at an optimal conveying speed in the fixing device 60. The non-fixed toner images on the paper P conveyed to the fixing device 60 undergo a fixing process by means of the fixing device 60 thermally and with pressure, thus being fixed on the paper P. Furthermore, the paper P on which the fixing images are formed is conveyed to a discharge disposition unit provided in the discharge unit of the image forming apparatus.

Meanwhile, after the transfer to the paper P is finished, the remaining toners on the intermediate transfer belt 15 are conveyed to a cleaning unit as the intermediate transfer belt 15 rotates, and are thus removed from the intermediate transfer belt 15 by means of the cleaning backup roller 34 and the intermediate transfer belt cleaner 35.

The fixing device 60 used in the image forming apparatus according to the present embodiment will be below described.

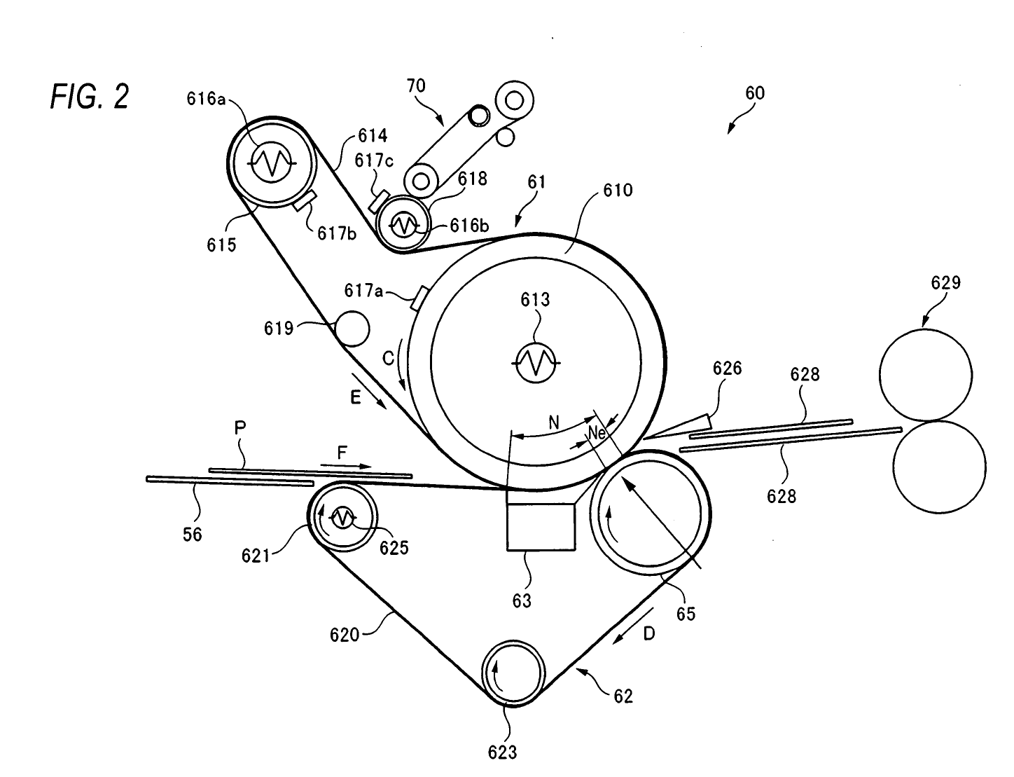

FIG. 2 is a lateral sectional view showing the construction of the fixing device 60 according to the present embodiment. The fixing device 60 mainly includes a fixing belt module (a turning member) 61 as an example of a heating member, and a pressing belt module 62 as an example of a compress member.

The fixing belt module 61 includes a fixing roller 610 that rotates, a stretching roller 615 having a halogen heater 616a as a heating member disposed therein, a stretching roller 618 having a halogen heater 616b as a heating member disposed therein, and a support roller 619 that supports a fixing belt 614 between the fixing roller 610 and the stretching roller 615. The fixing belt 614 is stretched by the fixing roller 610, the stretching roller 615, the stretching roller 618 and the support roller 619, and moves in a direction of an arrow E.

The fixing roller 610 is a hard roller made of SUS, and it has a thickness of 5 mm, an outer diameter of 100 mm and a length of 380 mm. Furthermore, the fixing roller 610 rotates at a surface velocity of 440 mm/s in a direction of an arrow C by means of a driving unit (not shown), which is disposed in the image forming apparatus body.

Furthermore, a halogen heater 613 having rating power of 1000 W as a heat source is disposed within the fixing roller 610. The control unit 40 (see FIG. 1) of the image forming apparatus controls a surface temperature of the fixing roller 610 to be 160° C. based on a measurement value of the temperature sensor 617a disposed to have a contact with a surface of the fixing roller 610.

The fixing belt 614 has a multi-layer structure of a base layer made of polyimide resin of 75 μm in thickness, an elastic member layer, which is laminated on a surface (a circumference surface side) of the base layer and is formed of silicon rubber of 200 μm in thickness, and a surface layer, which is formed on the elastic member layer and is formed of tetrafluoroethylene-perfluoroalkylvinylether copolymer resin (PFA) having a thickness 30 μm, as a peeling layer. The fixing belt 614 is a flexible endless belt having a circumference length of 330 mm and a width of 340 mm. In this case, the elastic member layer is provided in order to improve the picture quality of color images. In the present embodiment, the elastic member layer is formed of silicon rubber having rubber hardness of 20° (JIS-A). In addition, a material, a thickness, hardness, and the like of the fixing belt 614 can vary according to an apparatus design condition such as a user purpose and a use condition.

Furthermore, the fixing belt 614 is stretched with tension of 10 kgf by means of the fixing roller 610, the stretching roller 615, the stretching roller 618 and the support roller 619.

The stretching roller 615 includes a stainless pipe roller having an outer diameter of 23 mm, a thickness of 2 mm and a length of 350 mm. The halogen heater 616a having rating power of 800 W as the heat source is disposed within the stretching roller 615. The surface temperature of the stretching roller 615 is controlled to be 200° C. by means of the temperature sensor 617b and the control unit 40 (see FIG. 1) . Accordingly, the stretching roller 615 serves to stretch the fixing belt 614 and also to heat the fixing belt 614.

Furthermore, the stretching roller 615 has a so-called crown shape in which a central portion thereof has an outer diameter greater 100 μm than an end thereof in order to make displacement of the fixing belt 614, in its axial direction as small as possible and also make uniform tension applied to the fixing belt 614 in its width direction.

Further, a belt edge position detection unit (not shown in the drawings), for detecting an edge position of the fixing belt 614, is disposed near the stretching roller 615. Furthermore, the stretching roller 615 has a shaft displacement device for displacing a contact position in the fixing belt 614 in its axial direction according to a detection result of the belt edge position detection device. The shaft displacement device is also constructed to control meandering (belt walk) of the fixing belt 614.

The stretching roller 618 consists of a peeling layer, which is formed by coating PFA of 20 μm in thickness on a base of a stainless pipe roller having an outer diameter of 23 mm, a thickness of 2 mm and a length of 350 mm. The peeling layer serves to prevent some offset toners or paper powders from an outer circumference of the fixing belt 614 from being accumulated on the stretching roller 618. Furthermore, the stretching roller 618 has a so-called crown shape in which a central portion thereof has an outer diameter greater 100 μm than an end thereof, in order to make displacement of the fixing belt 614 in its axial direction as small as possible and also make uniform tension applied to the fixing belt 614 in its width direction. It has been described above that both the stretching roller 615 and the stretching roller 618 have a crown shape. It is, however, to be understood that either the stretching roller 615 or the stretching roller 618 can have a crown shape.

The halogen heater 616b having rating power of 800 W as a heat source is disposed within the stretching roller 618. A surface temperature of the halogen heater 616b is controlled to be 200° C. by means of the temperature sensor 617c and the control unit 40 (see FIG. 1). Accordingly, the stretching roller 618 serves to stretch the fixing belt 614 and also to heat the fixing belt 614 from its outer surface. Therefore, since the halogen heater 616a as the heat source is also disposed within the stretching roller 615, the fixing belt 614 is heated by both the stretching roller 615 and the stretching roller 618 in the present embodiment.

Furthermore, the stretching roller 618 serves as a tension roller that applies tension of 10 kgf to the entire fixing belt 614.

A cleaning web device 70 for cleaning offset toners or paper powders, which are adhered on the surface of the stretching roller 618 from an outer circumference of the fixing belt 614, is disposed in the stretching roller 618. The cleaning web device 70 has a contact with the surface of the stretching roller 618.

The construction of the pressing belt module 62 will now be described. The pressing belt module 62 includes a pressing belt (a belt member) 620 that is stretched by means of three rollers of an inlet roller 621, a pressing roller 65 and a stretching roller 623, and a pressure pad (a pressing member) 63 disposed with it being pressed against the fixing roller 610 through the pressing belt 620 within the pressing belt 620. Further, the pressing belt 620 rotates in a direction of an arrow D, following the fixing roller 610 as the fixing roller 610 of the fixing belt module 61 rotates in a direction of an arrow C. The progress speed of the pressing belt 620 is 440 mm/s, which is the same as the surface velocity of the fixing roller 610.

A nip part N, which causes the pressing belt 620 to press against an outer circumference of the fixing belt 614, is formed at a portion where the pressing belt module 62 and the fixing belt module 61 are brought into contact with each other, within the region where the fixing belt 614 is wound (lapped) on the fixing roller 610 (this region is also referred to as “lap region”).

In the nip part N, the pressure pad 63 is disposed within the pressing belt 620 with it being pressed toward the fixing roller 610 through the pressing belt 620, so that it presses the pressing belt 620 against the lap region of the fixing roller 610. Furthermore, the pressing roller (a roller member) 65 is disposed at the lowest downstream portion of the nip part N. Further, the pressing roller 65 is pressed (pressed) toward the center axis of the fixing roller 610 through the pressing belt 620 and the fixing belt 614, and applies local high pressure to the contact portion of the fixing roller 610 and the fixing belt 614.

In the fixing device 60 of the present embodiment, the nip part N is formed as a stripe forming region that extends 45° as a central angle regarding the rotation axis of the fixing roller 610 (this central angle is also referred to as “lap angle”). In this case, the nip width is 26 mm.

The pressing belt 620 includes a base layer, a peeling layer coated on one surface or both surfaces of the fixing roller 610, and an elastic member layer formed between the base layer and the peeling layer. Further, the base layer can be formed of resin having high heat-resistant strength such as polyimide, polyamide or polyamideimide. The base layer has a thickness of about 50 to 125 μm, more preferably 75 to 100 μm.

Further, the peeling layer can be preferably formed of fluorine resin, e.g., PFA having a thickness of 5 to 20 μm. In addition, the elastic member layer can be formed of silicon rubber having a thickness of 20 to 500 μm, preferably 50 to 300 μm and rubber hardness of 8 to 70° (JIS-A), preferably 15 to 30° (JIS-A).

In the fixing device 60 of the present embodiment, the elastic member layer formed of silicon rubber having rubber hardness of 30° (JIS-A) and a thickness of 100 μm, and the peeling layer formed of fluorine resin (PFA) of 30 μm in thickness, as the pressing belt 620, are laminated on an outer circumferential surface (on the part of the fixing belt module 61) of the base layer formed of a polyimide film having a thickness of 75 μm, a width 340 mm and a circumference length of 288 mm.

Further, the three rollers that stretch the pressing belt 620 includes the inlet roller 621 of a stainless material, the pressing roller 65 to be described later in detail, and the stretching roller 623 of a stainless material. They stretch the pressing belt 620 with tension of 10 kgf. The three rollers have outer diameters of 30 mm, 60 mm and 30 mm, respectively, and a length of 350 mm. Further, a halogen heater 625 as the heat source is disposed within the inlet roller 621.

Furthermore, a surface temperature of each of the three rollers is controlled to be 120° C. by means of a temperature sensor (not shown) and the control unit 40 (see FIG. 1), so that preliminary heat can be applied to the pressing belt 620.

Furthermore, a belt edge position detection unit (not shown in the drawings) for detecting an edge position of the pressing belt 620 is disposed near the stretching roller 623. The stretching roller 623 further includes a shaft displacement unit for displacing a location at which the stretching roller 623 has a contact with the pressing belt 620 in its axial direction based on a detection result of the belt edge position detection unit, thus controlling meandering (belt walk) of the pressing belt 620.

The pressure pad 63 as a pressing member includes an elastic member for securing the nip part N having a wide width, and a low friction layer provided on a surface in which the elastic member has a contact with an inner surface of the pressing belt 620. The pressure pad 63 is maintained by a holder (not shown in the drawing), which is made of metal. The elastic member having a low friction layer is a concave shape in which the fixing roller 610 almost copies the circumference of the fixing roller 610. The elastic member is pressed against the fixing roller 610, and it forms an inlet-side region of the nip part N formed in the lap region of the fixing roller 610.

The elastic member of the pressure pad 63 can employ an elastic member having a high heat-resistant property, such as silicon rubber or fluorine rubber, a leaf spring or the like. The low friction layer formed on the elastic member serves to make small sliding resistance between the inner circumference of the pressing belt 620 and the pressure pad 63. It is preferred that the low friction layer is formed of a material having a low coefficient of friction and a wear-resisting property. In particular, the low friction layer can be formed of glass fiber sheet in which Teflon (trademark) is impregnated, fluorine resin sheet, a fluorine resin coating film or the like.

In addition, the pressure pad 63 can have a pad shape as in the present embodiment, or a roller shape. The pad can be made to follow (move) such that it is pressed against the surface of the fixing roller 610 by means of the pressing belt 620. However, the pressure pad 63 having the pad shape as in the present embodiment can apply nip pressure widely and uniformly over the entire nip part N.

A fixing operation of the fixing device 60 according to the present embodiment will now be described.

In the secondary transfer unit 20 (see FIG. 1) of the image forming apparatus, the paper P on which the non-fixed toner images are electrostatically transferred is conveyed to the nip part N of the fixing device 60 (in a direction of an arrow F) by means of the conveying belt 55 and the fixing inlet guide 56. The non-fixed toner images on the surface of the paper P that passes through the nip part N are then fixed on the paper P by means of pressure and heat acting on the nip part N. Thereafter, the paper P is separated from the fixing belt 614 by means of the paper separation member 626, and is then guided into the discharged paper guide 628 and the discharged paper roller 629. It is then mounted in a paper discharge disposition unit (not shown in the drawings).

In the fixing device 60 of the present embodiment, the nip part N can be set wide through the construction in which the fixing roller 610 having the fixing belt 614 lapped thereon and the pressing belt 620 are brought into contact with each other, while pressing the pressure pad 63, as described above. It is thus possible to secure a stabilized fixing performance.

At this time, in the fixing device 60 of the present embodiment, heat applied to the nip part N is mainly supplied from the fixing belt 614. The fixing belt 614 is adapted to be heated by heat supplied from the halogen heater 613 disposed within the fixing roller 610 through the fixing roller 610, heat supplied from the halogen heater 616a disposed within the stretching roller 615 through the stretching roller 615, and heat supplied from the halogen heater 616b disposed within the stretching roller 618 through the stretching roller 618. Due to this, although thermal energy is insufficient through only the fixing roller 610, it can be supplied from the stretching roller 615 and the stretching roller 618 properly and rapidly. In the nip part N, it is possible to secure a sufficient heat quantity although the process speed is high speed of 440 mm/s.

In other words, in the fixing device 60 of the present embodiment, the fixing belt 614 serving as a direct heating member can have a very low heat capacity. Further, the fixing belt 614 is constructed to have a contact with the fixing roller 610, the stretching roller 615 and the stretching roller 618 all of which are heat supply members in a wide lap area (a high lap angle). Therefore, in a short period where the fixing belt 614 rotates once, a sufficient heat quantity can be supplied from the fixing roller 610 or the stretching roller 615 and the stretching roller 618. It is thus possible to return the fixing belt 614 to a desired fixing temperature in a short time. Accordingly, although the speed of the fixing device 60 is high, the nip part N can be always kept to a predetermined fixing temperature.

Consequently, in the fixing device 60 of the present embodiment, when a high-speed fixing operation begins, generation of a temperature drop phenomenon in which a fixing temperature lowers can be prevented. In particular, even in the case of fixing such as thick paper having a high heat capacity, generation of a temperature drop can be prevented.

Further, even when there is a need to switch a fixing temperature corresponding to the type of paper (including both the up and down of the fixing temperature), switching to a desired temperature can be made easily and rapidly by controlling the outputs of the halogen heater 613, the halogen heater 616a and the halogen heater 616b since the fixing belt 614 has a low heat capacity.

Further, in the fixing device 60 of the present embodiment, the pressing belt 620 of the pressing belt module 62 is constructed to have a contact with an outer circumference of the fixing belt 614 only within the region (the lap region) where the fixing belt 614 is wound on the surface of the fixing roller 610 in the nip part N. That is, in the nip part N, the fixing roller 610 is disposed across the entire region on an inner circumference of the fixing belt 614. Accordingly, the fixing belt 614 and the pressing belt 620 are brought into contact with each other with them being supported by the surface of the fixing roller 610 in a stable way. They can be uniformly adhered to the entire region of the nip part N. Since thermal conduction from the fixing belt 614 to the paper P can be carried out efficiently because of good adhesiveness between the fixing belt 614 and the pressing belt 620, generation of a temperature drop can be prohibited in a more effective way.

Further, in the fixing device 60 of the present embodiment, the pressing roller 65 is disposed such that it is pressed against a center axis of the fixing roller 610 in the lowest downstream portion of the nip part N. The pressing roller 65 also applies a high local pressure to melted toner images. As such, high fixity can be secured, and the surface of the toner images can become smooth. More particularly, a good image glazing effect can be given to color images.

In this case, in the lowest downstream portion of the nip part N, the pressing roller 65 pressed against the center axis of the fixing roller 610 will be below described.

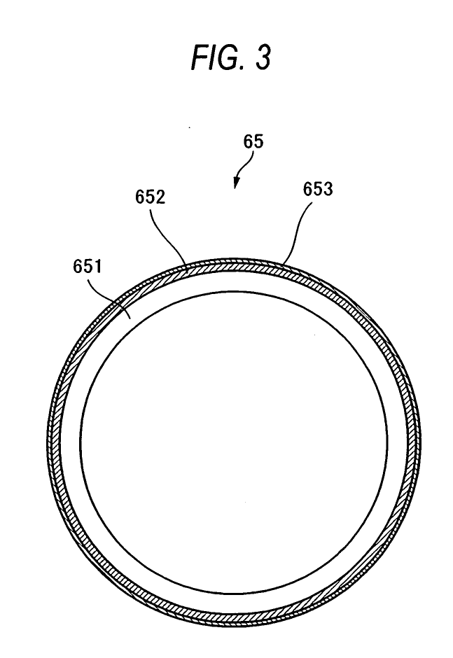

The construction of the pressing roller 65 will be first described. FIG. 3 is a sectional view showing the construction of the pressing roller 65.

As shown in FIG. 3, the pressing roller 65 is a roller member in which an elastic layer 652 and a surface layer 653 made of a material having a higher volume elastic modulus than that of the elastic layer 652 are coated on an outer circumference of a base 651, using a pipe (a cylindrical body) of a SUS material as the base 651.

In the fixing device 60 of the present embodiment, the pressing roller 65 has the elastic layer 652 made of silicon rubber having a thickness of 3 mm, and the surface layer 653 made of PFA having a thickness of 100 μm, both of which are laminated on the base 651 having an outer diameter of 60 mm and a length of 350 mm.

Further, the pressing roller 65 has a so-called flare shape in which an outer diameter of a central portion in a longitudinal direction becomes gradually smaller several 100 μm than that of both ends. In the pressing roller 65, bending of a bow shape in a longitudinal direction, which looks concave against a direction where the central portion of the pressing roller 65 is oriented toward the compression side, is generated when the roller is pressed against the fixing roller 610 from both ends. For this reason, if the pressing roller 65 is constructed to have a flare shape, a path difference in a rotation direction of the pressing belt 620 (a radius difference in a rotation direction of the pressing belt 620 is generated in a central portion having a high warp deformation amount and both ends having a low warp deformation amount), which is incurred by warp deformation of the pressing roller 65, can be prohibited. In addition, in order to construct the pressing roller 65 having a flare shape, the pressing roller 65 can be finally formed in a flare shape. The base 651 can be also made in a flare shape, and the elastic layer 652 or the surface layer 653 can be formed in a flare shape. At this time, a flare amount can be properly set in consideration of a warp deformation amount, etc. of the pressing roller 65 according to load acting on the pressing roller 65.

The function of the pressing roller 65 will now be described. As described above, the pressing roller 65 presses the pressing belt 620 against the fixing roller 610 with tension of e.g., 100 kgf, while stretching the pressing belt 620.

Thereby, a high-pressure nip part Ne to which high pressure is locally applied is formed in the lowest downstream portion of the nip part N in which the pressing roller 65 is pressed against the fixing roller 610 (see FIG. 2). At this time, in the high-pressure nip part Ne, since strain is generated in the elastic layer 652 of the pressing roller 65, the high-pressure nip part Ne is formed to have a width of e.g., 6 mm. Further, when the paper P passes through the high pressure nip part Ne having a predetermined width, the high pressure nip part Ne sufficiently presses melted toner images in the region of the nip part N where the pressure pad 63 is disposed in a layer direction, so that the surface of a toner image can become sufficiently smooth. Thereby, in the fixing device 60 of the present embodiment, a high fixity can be realized and a good image glazing effect can be obtained.

In the case where the pressing roller 65 has the base 651 and the elastic layer 652 as in the prior art and thus has its outer circumference not coated with the surface layer 653, however, there is a problem in that strain of a wave shape or wrinkles in a rotation direction of the pressing roller 65 is generated in the stretched pressing belt 620. In this case, in order to explain the function of the surface layer 653 disposed in its outer circumference, mechanism in which strain of a wave shape or wrinkles in the rotation direction of the pressing roller 65 is generated in the pressing belt 620 in the conventional fixing device will be first described.

As described above, when the pressing roller 65 is pressed against the fixing roller 610, stain (compression toward the base 651) is generated in the elastic layer 652 in which the pressing roller 65 is formed. Furthermore, when the paper P having a relatively small size such as B5 size passes through the high pressure nip part Ne, there occurs a phenomenon in which a strain amount (this is also referred to as “compression amount”) of the elastic layer 652 is different in a region through which the paper P passes and a region through which the paper P does not pass in a width direction of the pressing roller 65.

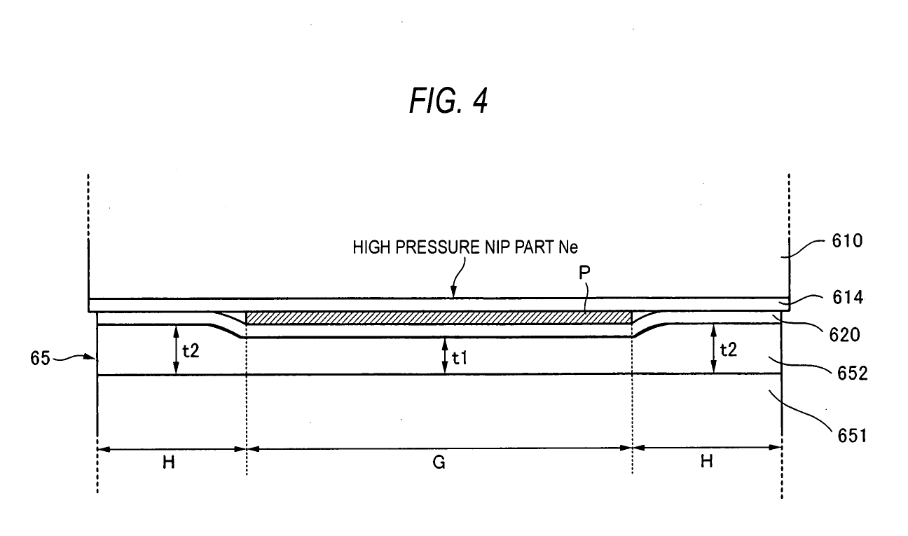

In this case, in FIG. 4, there is shown a sectional view of the high-pressure nip part Ne, which is viewed from an upper side of a conveying direction of the paper P. As shown in FIG. 4, in the high pressure nip part Ne, a compression amount generated in the elastic layer 652 is greater in a region G through which the paper P passes than in a region H through which the paper P does not pass as much as a thickness of the paper P. To be more precise, assuming that an original layer thickness (a layer thickness in a state where load is not applied) of the elastic layer 652 is “t”, the relation of approximately t2=t1+p (where, “p” is a paper thickness of the paper P) is established between a layer thickness t1 of the elastic layer 652 in the region G through which the paper P passes and a layer thickness t2 of the elastic layer 652 in the region H through which the paper P does not pass. Accordingly, a compression amount Δδ1(=t−t1) of the elastic layer 652 in the region G through which the paper P passes becomes greater than a compression amount Δδ2(=t−t2) of the elastic layer 652 in the region H through which the paper P does not pass. That is, Δδ1>Δδ2.

A surface velocity of the pressing roller 65 will be then taken into consideration. In the construction in which the pressing roller 65 has elasticity by means of the elastic layer 652, it is known that a surface velocity Ve of the pressing roller 65 in the high pressure nip part Ne where stain is generated as the pressing roller 65 is pressed against the fixing roller 610 is faster than a surface velocity Vo in regions other than the high pressure nip part Ne, wherein pressing force is not applied to the pressing roller 65. Furthermore, at this time, the relation of Ve=(1+ε)Vo is established between the surface velocity Ve and the surface velocity Vo. The relational formula can be induced by non-compression of the elastic member (Poison's ratio is about 0.5 and a volume elastic modulus is 0.003 to 3) and continuity of the elastic member amount that moves per unit. In addition, ε is strain generated in the pressing roller 65 (ε=compression amount Δδ/ original layer thickness t of the elastic layer 652).

Accordingly, as described above, since the compression amount has the relation of Δδ1>Δδ2, strain ε1 (ε1=Δ/δt) generated in the elastic layer 652 in the region G through which the paper P passes is greater than strain ε2 (ε2=Δδ2/t) generated in the elastic layer 652 in the region H through which the paper P does not pass. That is, strain generated in the elastic layer 652 has the relation of ε1>ε2.

Due to this, in the high pressure nip part Ne, from the relation of Ve=(1+ε)Vo, a surface velocity Ve1 (Ve1=(1+ε1)Vo) of the pressing roller 65 in the region G through which the paper P passes becomes greater than a surface velocity Ve2 (Ve2=(1+ε2)Vo) of the pressing roller 65 in the region H through which the paper P does not pass. That is, in the surface velocity of the pressing roller 65, the relation Ve1>Ve2 is established.

As such, in the high pressure nip part Ne, the surface velocity of the pressing roller 65 becomes faster in the region G through which the paper P passes than in the region H through which the paper P does not pass. Due to this, in the same manner as the pressing belt 620 stretched by the pressing roller 65, a rotation speed of the pressing belt 620 becomes higher in the region G through which the paper P passes than in the region H through which the paper P does not pass.

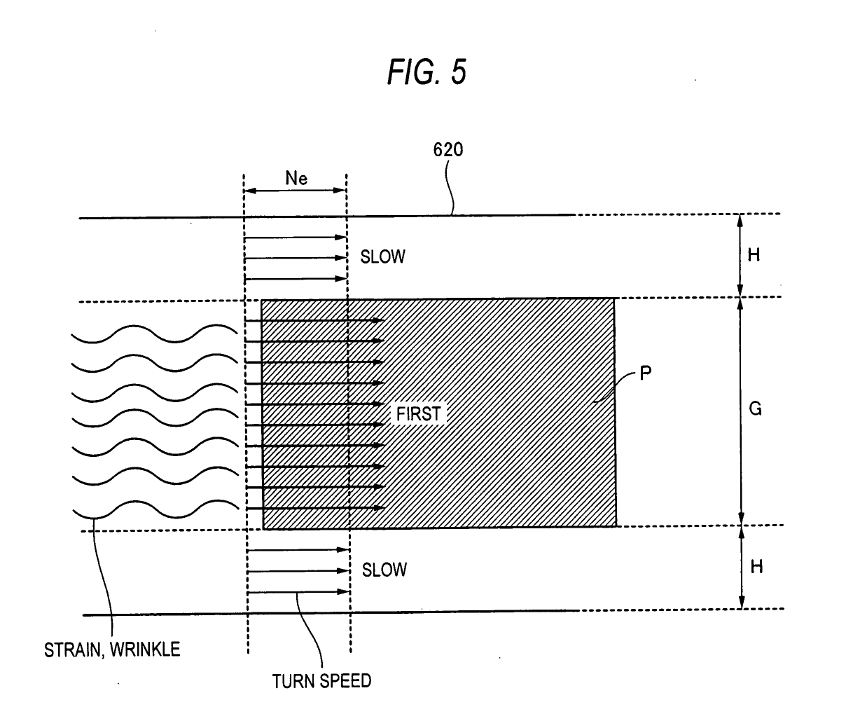

In this case, in FIG. 5, there is shown distribution of the rotation speed in a width direction of the pressing belt 620.

As shown in FIG. 5, the rotation speed of the pressing belt 620 is relatively high in the region G through which the paper P passes, but is low in the region H through which the paper P does not pass. For this reason, the region G through which the paper P passes is applied with force, which is oriented from the region H through which the paper P located at both ends of the width direction thereof does not pass toward a central portion of the width direction, and thus becomes gradually loose. As a result, strain of a wave shape or wrinkles in the rotation direction of the pressing belt 620, as shown in FIG. 5, is generated.

As such, if strain of a wave shape or wrinkles in the rotation direction is generated in the pressing belt 620, adhesiveness between the fixing belt 614 and the paper P becomes low. This makes weak fixity to toner images, thus degrading the picture quality. Further, since so-called glazing spots in which a brilliance of toner images lowers is generated, there is a phenomenon in which lowering in the picture quality can be seen in a solid image such as a photo image.

In the fixing device 60 of the present embodiment, the pressing roller 65 has its outer circumference coated with the surface layer 653 made of a material having a higher volume elastic modulus than that of the elastic layer 652. As such, if the outer circumference of the pressing roller 65 is coated with the surface layer 653 made of a material having a volume elastic modulus higher than that of the elastic layer 652 disposed therein, it is possible to prohibit low a difference in the compression amount Δδ, which is generated in the elastic layer 652 between the region G through which the paper P passes and the region H through which the paper P does not pass. Due to this, in the high pressure nip part Ne, strain ε generating on the surface of the pressing roller 65 can be set in such a way not to have a great difference between the region G through which the paper P passes and the region H through which the paper P does not pass. It is thus possible to uniformly set a surface velocity of the pressing roller 65 in a width direction. Consequently, since the rotation speed in the width direction of the pressing belt 620 becomes uniform, strain of a wave shape or wrinkles in the rotation direction can be prevented in the pressing belt 620.

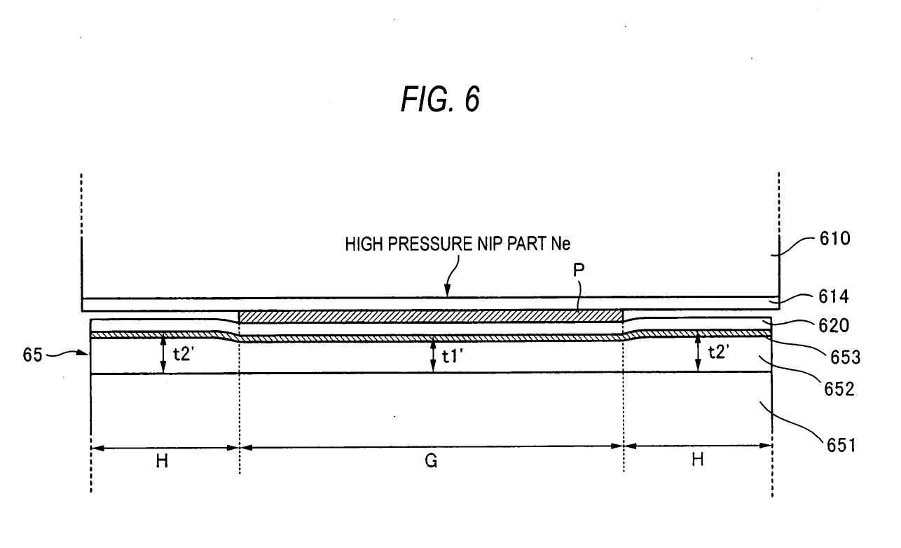

FIG. 6 is a view showing the shape of the surface layer 653 in which a difference in the compression amount Δδ, which is generated in the elastic layer 652, is prohibited low in the pressing roller 65. In this case, FIG. 6 also shows a sectional view of the high-pressure nip part Ne, which is seen from an upstream side of the conveying direction of the paper P, in the same manner as FIG. 4.

As shown in FIG. 6, if the paper P of a small size is conveyed to the high pressure nip part Ne, the elastic layer 652 of the pressing roller 65 tries to be strained more in the region G through which the paper P passes than in the region H through which the paper P does not pass as much as a paper thickness of the paper P, in the same manner as the previous example (see FIG. 4). Since the surface layer 653 coated on the outer circumference of the elastic layer 652 is made of a material having a volume elastic modulus higher than that of the elastic layer 652, however, strain is not generated in the surface layer 653 like the elastic layer 652. For this reason, strain in the region G through which the paper P passes in the elastic layer 652 can be prohibited.

At the same time, the volume elastic modulus of the surface layer 653 is high and the strain amount of the surface layer 653 itself is low. Accordingly, force, which tries to make uniform the strain amount of the entire surface layer 653 in its width direction, is applied to the surface layer 653. Due to this, force that tries to make strained the elastic layer 652, although it is a little, is applied in the region H through which the paper P does not pass in cooperation with strain of the surface layer 653 in the region G through which the paper P passes. That is, in the region G through which the paper P passes, the layer thickness t1 of the elastic S layer 652 in the previous example (see FIG. 4) and a layer thickness t1′ of the elastic layer 652 in the pressing roller 65 of the present embodiment (see FIG. 6) has the following relation, t1<t1′. On the other hand, in the region H through which the paper P does not pass, a layer thickness t2′ of the elastic layer 652 in the pressing roller 65 of the present embodiment and the layer thickness t2 of the elastic layer 652 in the previous example has the following relation, t2≧t2′. As such, in the high-pressure nip part Ne, a difference between the layer thickness t1′ of the elastic layer 652 in the region G through which the paper P passes and the layer thickness t2′ of the elastic layer 652 in the region H through which the paper P does not pass can be prohibited low.

Due to this, a difference between a compression amount Δδ1′ (=t−t1′) of the elastic layer 652 in the region G through which the paper P passes and a compression amount Δδ2′ (=t−t21) of the elastic layer 652 in the region H through which the paper P does not pass is sufficiently low compared to the previous one (see FIG. 4). It is thus possible to make sufficiently small a difference between a surface velocity Ve1′ of the pressing roller 65 in the region G through which the paper P passes and a surface velocity Ve2′ of the pressing roller 65 in the region H through which the paper P does not pass. As described above, the surface layer 653 serves as a speed difference control layer that controls a difference in the surface velocity of the pressing roller 65, which is generated in its width direction because of a difference in a strain amount in the elastic layer 652, to be approximately uniform.

Furthermore, in the same manner as the pressing belt 620 stretched by the pressing roller 65, a difference between the surface velocity Ve1′ of the pressing belt 620 in the region G through which the paper P passes and the surface velocity Ve2′ of the pressing belt 620 in the region H through which the paper P does not pass becomes sufficiently small. It is therefore possible to prohibit generation of strain of a wave shape or wrinkles in a rotation direction of the pressing belt 620.

Due to this, high adhesiveness can be maintained between the fixing belt 614 and the paper P. Fixity to toner images can be secured and high quality fixing images can be obtained. Further, since an appropriate brilliance of toner images can be obtained, fixing images with a high quality can be obtained in a solid image such as, especially, a photo image.

A material used in the surface layer 653 of the pressing roller 65 will now be described. The material of the surface layer 653 can include a material having a volume elastic modulus higher than that of a rubber material such as silicon rubber, which is generally used in the elastic layer 652, from the viewpoint where it is difficult to generate strain than in the elastic layer 652.

To be more specific, the rubber material generally has a volume elastic modulus of 0.003 to 3. Thus, the surface layer 653 is formed of a material having a volume elastic modulus higher than 0.003 to 3. It is also preferred that the surface layer 653 is formed of a material having a Poison's ratio lower than that of the rubber material. In particular, since the rubber material generally has a Poison's ratio of 0.5, the surface layer 653 is formed of a material having a Poison's ratio lower than 0.5. In view of the above, fluorine resin such as PFE having a volume elastic modulus of 0.1 to 40 and Poison's ratio of 0.25 to 0.45 is suitable as the material of the surface layer 653.

The material of the surface layer 653 is not limited to fluorine resin. It is, however, preferred that the material of the surface layer 653 is a material having a low non-compression effect compared to the rubber material used in the non-compression elastic layer 652, i.e., resin having a high volume elastic modulus and a low Poison's ratio compared to the elastic layer 652. In other words, the surface layer 653 can be better if it is possibly strong from the viewpoint where it generates less strain than the elastic layer 652. However, the surface layer 653 also needs abundant expansion and contraction and a good flexibility. This is because wrinkles or cracks are generated in the surface layer 653 itself if the surface layer 653 cannot follow the surface layer 653 by some degree even when the pressing roller 65 is pressed against the fixing roller 610 and the elastic layer 652 is deformed. In view of this, it is required to select a suitable material as the material of the surface layer 653 according to its use purpose.

It is also preferred that the surface layer 653 has a heat-resistant property since it is applied with heat from the fixing belt 614.

Further, the surface layer 653 preferably has a low coefficient of friction against a relative movement since it is brought into contact with the pressing belt 620.

Even from this viewpoint, fluorine resin is an appropriate material of the surface layer 653. However, the material of the surface layer 653 can also include polyimide resin, polyamideimde resin or the like.

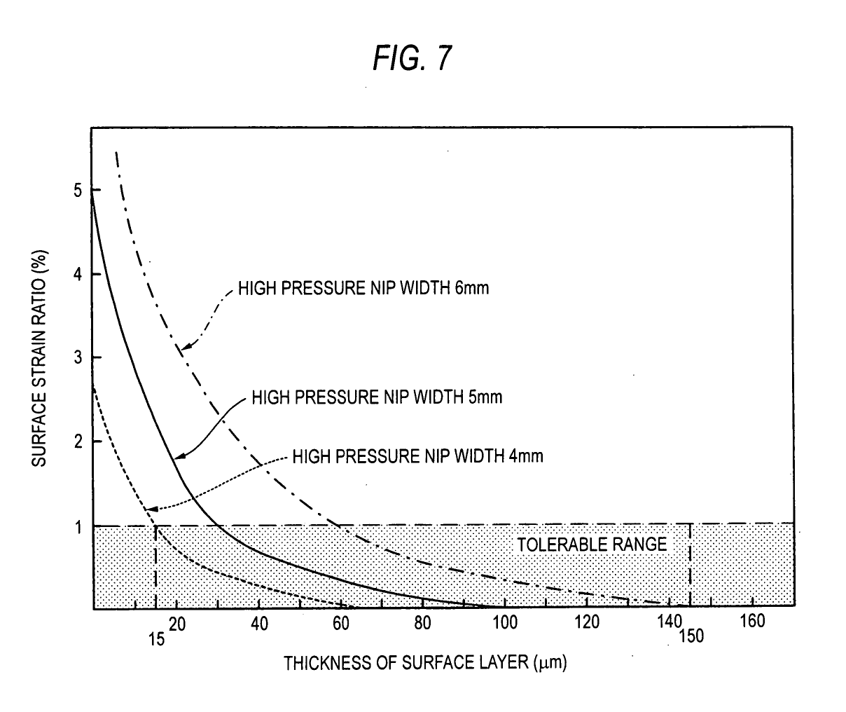

A thickness of the surface layer 653 of the pressing roller 65 will be below described. In this case, an experiment in which a width of the high pressure nip part Ne was changed by varying pressing force in which the pressing roller 65 presses the fixing roller 610, and the relation between the thickness of the surface layer 653 and the surface strain ratio of the pressing roller 65 was examined every high pressure nip part width, was carried out. At this time, the elastic layer 652 was formed of silicon rubber (the volume elastic modulus was 0.003 to 3 and the Poison's ratio was 0.5), and the surface layer 653 was formed of PFA (fluorine resin: the volume elastic modulus was 0.1 to 40 and the Poison's ratio was 0.25 to 0.45). The experiment result is shown in FIG. 7.

A set value of a thickness of the surface layer 653 was found based on the result of FIG. 7. In the case where this experiment was performed, if the surface strain ratio of the pressing roller 65 was within 1%, it was found that strain of a wave shape or wrinkles in the pressing belt 620 could be prohibited within a tolerable range even in the case where the paper P of a small size passed according to a previous experiment. Accordingly, from the result of FIG. 7, it could be seen that the thickness of the surface layer 653 was 15 to 150 μm, which was appropriate as a range to fulfill the surface strain ratio of 1%. That is, if the thickness of the surface layer 653 is set to 15 to 150 μm, strain of a wave shape or wrinkles may not be generated in the pressing belt 620 in such a way that the pressing roller 65 controls the width of the high pressure nip part Ne by means of pressing force that presses the fixing roller 610.

Furthermore, the result of FIG. 7 suggests that the thickness of the surface layer 653 in which the surface strain ratio of the pressing roller 65 becomes 0% exists in setting the width of the high-pressure nip part Ne. Due to this, it is possible to solve the problem of strain of a wave shape or wrinkles in the pressing belt 620, which is incurred due a difference in the surface velocity generated in the pressing roller 65 by properly setting the thickness of the surface layer 653 according to the width of the high pressure nip part Ne.

In the fixing device 60 of the present embodiment, an experiment for confirming effects obtained by providing the surface layer 653 in the pressing roller 65 was carried out. In this experiment, the pressing roller 65 was formed by laminating the elastic layer 652 made of silicon rubber having a thickness 3 mm and the surface layer 653 made of PFA having a thickness of 100 μm on the base 651 whose outer diameter is 60 mm and whose length is 350 mm. In this state, whether strain of a wave shape or wrinkles was generated in the pressing belt 620 was evaluated. In this experiment, the same experiment was performed on the pressing roller 65 in which the surface layer 653 was not provided, and was used as a comparison example.

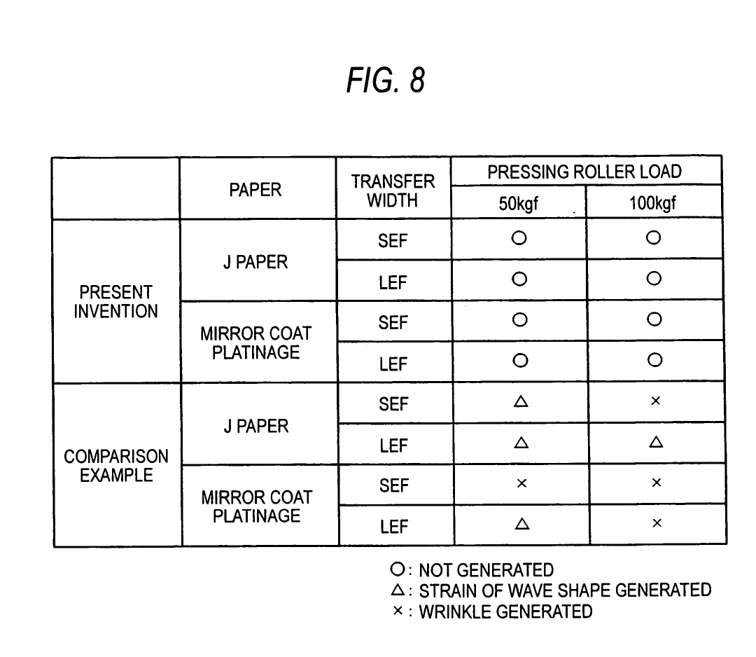

Further, the width of each of the fixing belt 614 and the pressing belt 620 used in this experiment was 340 mm. Furthermore, two kinds of A4 size; Mirror Coat Platinage of square 256 gsm and J paper available from Fuji Xerox Information Systems were used. In addition, the conveying direction of the paper P was performed as a A4 parallel transfer (LEF: Long Edge Feed, 298 mm in width) and A4 perpendicular transfer (SEF: Short Edge Feed, 210 m in width), respectively. Furthermore, a total of load applied to the pressing roller 65 was 50 kgf and 100 kgf. Further, a temperature of the fixing belt 614 was set to 180° C. When the paper P was conveyed at a process speed of 440 mm/s, whether strain of a wave shape or wrinkles was generated in the pressing belt 620 when the paper P of 100,000 sheets passed was examined. The experiment result is shown in FIG. 8.

In the event that wrinkle is generated in the pressing belt 620, strain of a wave shape is first generated in a width direction of the pressing belt 620 as a preliminary step in which wrinkle is generated. Furthermore, if the strain level of a wave shape is further aggravated, wrinkles are formed in the pressing belt 620 as permanent marks. Therefore, in the evaluation of FIG. 8, three steps were carried out assuming that a level in which strain of a wave shape or wrinkles is never generated was set to O, a level in which strain of a wave shape was generated but it does not reach wrinkles was set to Δ, and a level in which strain of a wave shape reaches wrinkles was set to X.

From FIG. 8, it can be seen that the pressing roller 65 having the surface layer 653 of the present embodiment disposed therein has a great effect in that generation of strain of a wave shape or wrinkles in the pressing belt 620 is prohibited, which is significantly superior to the conventional construction.

As described above, in the fixing device 60 of the present embodiment, the outer circumference of the elastic layer 652 in the pressing roller 65 that presses the fixing roller 610 in the lowest downstream portion of the nip part N is coated with the surface layer 653 having a volume elastic modulus higher than that of the elastic layer 652. Therefore, even when the paper P of, e.g., a small size passes through the high pressure nip part Ne in which the pressing roller 65 is pressed against the fixing roller 610, it is possible to make very small a difference between the surface velocity Ve1′ of the pressing roller 65 in the region G through which the paper P passes, and the surface velocity Ve2′ of the pressing roller 65 in the region H through which the paper P does not pass. Thereby, even in the pressing belt 620 stretched by the pressing roller 65, there is rarely a difference in the rotation speed between the region G through which the paper P passes and the region H through which the paper P does not pass. It is thus possible to prohibit generation of strain of a wave shape or wrinkles in a rotation direction of the pressing belt 620. Due to this, high adhesiveness can be obtained between the fixing belt 614 and the paper P, and fixity to toner images can be secured. It is thus possible to maintain fixing images with a high quality for a long time. Further, since a proper brilliance of toner images can be obtained, fixing images with a good quality can be formed in a solid image such as, especially, a photo image.

In addition, the fixing device 60 of the present embodiment includes the stretching roller 615 having the halogen heater 616a disposed therein along with the fixing roller 610, and the stretching roller 618 having the halogen heater 616b disposed therein. In this case, the stretching roller 615, the stretching roller 618 and the fixing roller 610 are stretched by the fixing belt 614 of an endless shape. Furthermore, the fixing belt 614 serves as a heating member that heats the paper P, and the fixing roller 610, the stretching roller 615 and the stretching roller 618 also serve as heat supply members to apply heat to the fixing belt 614. Due to this, although the speed of the fixing device 60 increases in the nip part N, a predetermined fixing temperature can be always maintained. It is thus possible to prohibit generation of a temperature drop.

Embodiment 2

Embodiment 1 relates to the image forming apparatus. The construction of the image forming apparatus in which the fixing device 60 is mounted using the fixing belt module 61, wherein the fixing belt 614 of an endless shape is stretched by means of the stretching roller 615 and the stretching roller 618, the fixing roller 610 as the assistant heating members, as the heating member used in the fixing device 60, has been described. In Embodiment 2, the construction of a fixing device 90 mounted in the image forming apparatus shown in FIG. 1, wherein only the fixing roller 610 is disposed as a heating member used in the fixing device 60 will be described. In addition, the same reference numerals are used to identify the same parts as those of Embodiment 1. Detailed description thereof will be thus omitted.

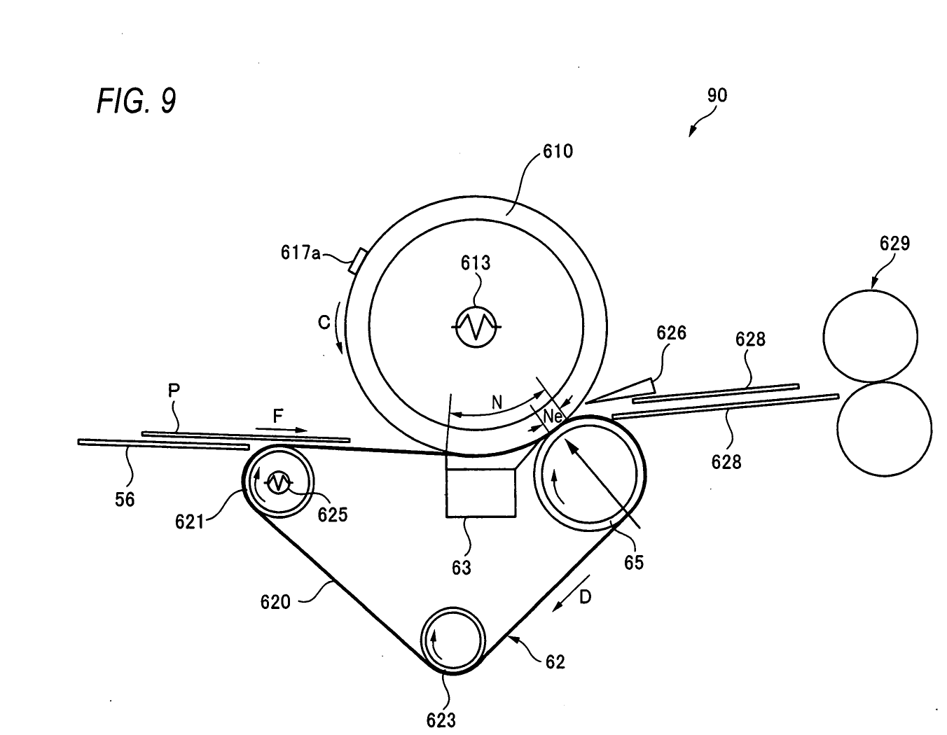

FIG. 9 is a lateral sectional view showing the construction of the fixing device 90 according to Embodiment 2. The fixing device 90 of the present embodiment is the same as the fixing device 60 of Embodiment 1 except that only the fixing roller (the rotary member) 610 is disposed instead of the fixing belt module 61 of Embodiment 1.

Even in the fixing device 90 of the present embodiment, the outer circumference of the elastic layer 652 in the pressing roller (the roller member) 65 that presses the fixing roller 610 in the lowest downstream portion of the nip part N is coated with the surface layer 653 made of a material having a volume elastic modulus higher than that of the elastic layer 652.

As such, in the same manner as Embodiment 1, even when the paper P of, e.g., a small size passes through the high pressure nip part Ne in which the pressing roller 65 is pressed against the fixing roller 610, it is possible to make very small a difference between the surface velocity Ve1′ of the pressing roller 65 in the region G through which the paper P passes and the surface velocity Ve2′ of the pressing roller 65 in the region H through which the paper P does not pass (see FIG. 6). Accordingly, even in the pressing belt (the belt member) 620 stretched by the pressing roller 65, there occurs rarely a difference in the rotation speed between the region G through which the paper P passes and the region H through which the paper P does not pass. It is thus possible to prevent generation of strain of a wave shape or wrinkles in the rotation direction of the pressing belt 620.

Due to this, high adhesiveness can be maintained between the fixing belt 614 and the paper P, and fixity to toner images can be secured. It is thus possible to obtain fixing images with a high quality. Further, since a proper brilliance of toner images can be obtained, fixing images with a good quality can be formed in a solid image such as, especially, a photo image.

Examples of the present invention can include an image forming apparatus such as copy machines and printers using electrophotography mode, and a fixing device for fixing non-fixed toner images carried on recording paper (paper). Examples of the present invention can also include an image forming apparatus such as copy machines and printers using ink jet mode, and a fixing device for drying non-dried ink images carried on recording paper.

As described so far, an aspect of the present invention is a fixing device that fixes toner images carried on a recording material. The device includes a rotary member, a belt member that is brought into contact with the rotary member, wherein a nip part through which the recording material passes is formed between the belt member and the rotary member, and a roller member that stretches the belt member and presses the belt member against the rotary member. At this time, the roller member includes an elastic layer, and a surface layer coated on a surface of the elastic layer, the surface layer being made of a material having a higher elastic modulus than that of the elastic layer.

In this case, in the roller member, the surface layer can have a lower Poison's ratio than that of the elastic layer. Further, a layer thickness of the surface layer of the roller member can be 15 to 150 μm. In addition, the surface layer of the roller member can be formed of resin. More particularly, the surface layer of the roller member can be formed of fluorine resin. In addition, the roller member can have a central portion whose outer diameter is smaller than that of both ends. Moreover, the rotary member can include a fixing roller having a heat source disposed therein, a fixing belt stretched by the fixing roller, and a stretching roller that stretches the fixing belt and has a heat source disposed therein.

Furthermore, a fixing device according to the present invention is a fixing device that fixes toner images carried on a recording material. The apparatus includes a rotary member, a belt member that is brought into contact with the rotary member, wherein a nip part through which the recording material passes is formed between the belt member and the rotary member, and a roller member having surface elasticity, for pressing the belt member against the rotary member while stretching the belt member. At this time, the roller member includes a surface layer that reduces strain generating in a width direction on a surface of the roller member.

In this case, the surface layer of the roller member can reduce a difference between a strain amount of the roller member in a region through which a recording material passes and a strain amount of the roller member in regions other than the region through which a recording material passes. Further, the surface layer of the roller member can be formed of a material having a higher elastic modulus than that of a rubber material. In addition, the surface layer of the roller member can be formed of a material having a lower Poison's ratio than that of rubber material.

Furthermore, an image forming apparatus according to the present invention includes a toner image forming unit for forming toner images, a transfer unit for transferring the toner images formed by the toner image forming unit to a recording material, and a fixing unit for fixing the toner images transferred on the recording material to the recording material. In this case, the fixing unit includes a rotary member, a belt member that is brought into contact with the rotary member, wherein a nip part through which the recording material passes is formed between the belt member and the rotary member, and a roller member that stretches the belt member and presses the belt member against the rotary member. Furthermore, the roller member includes an elastic layer, and a surface layer coated on a surface of the elastic layer, the surface layer being made of a material having a higher elastic modulus than that of the elastic layer.

In this case, in the fixing unit, the surface layer of the roller member can reduce a difference between a strain amount of the elastic layer in a region through which the recording material passes, and a strain amount of the elastic layer in regions other than the region through which the recording material passes. In addition, the surface layer of the roller member of the fixing unit can be formed to a layer thickness of 15 to 150 mn. Moreover, the surface layer of the roller member of the fixing unit can be formed of fluorine resin.

According to the present invention, in the fixing device using the belt member, strain of a wave shape or wrinkles can be prevented from occurring in the belt member. Fixing images with a high quality, which have a high fixity and a uniform and proper glazing property, can be maintained for a long term.

The entire disclosure of Japanese Patent Application No. 2005-074401 filed on Mar. 16, 2005 including specification, claims, drawings and abstract is incorporated herein by reference in its entirety.

What is claimed is:

1. A fixing device that fixes toner images carried on a recording material, comprising:
a rotary member;
a belt member that is brought into contact with the rotary member, wherein a nip part through which the recording material passes is formed between the belt member and the rotary member; and
a roller member that stretches the belt member and presses the belt member against the rotary member,
wherein the roller member includes an elastic layer, and a surface layer coated on a surface of the elastic layer, the surface layer being made of a material having a higher elastic modulus than that of the elastic layer.

2. The fixing device according to claim 1,
wherein in the roller member, the surface layer has a lower Poison's ratio than that of the elastic layer.

3. The fixing device according to claim 1,
wherein a layer thickness of the surface layer of the roller member is 15 to 150 μm.

4. The fixing device according to claim 1,
wherein the surface layer of the roller member is formed of resin.

5. The fixing device according to claim 4,
wherein the surface layer of the roller member is formed of fluorine resin.

6. The fixing device according to claim 1,
wherein the roller member has a central portion in its axis direction whose outer diameter of the cross-section is smaller than that of the cross-sections at both ends.

7. The fixing device according to claim 1,
wherein the rotary member includes a fixing roller having a heat source disposed therein, a fixing belt stretched by the fixing roller, and a stretching roller that stretches the fixing belt.

8. The fixing device according to claim 1,
wherein the rotary member includes a fixing roller having a heat source disposed therein, a fixing belt stretched by the fixing roller, and a stretching roller that stretches the fixing belt and has a heat source disposed therein.

9. A fixing device that fixes toner images carried on a recording material, comprising:
a rotary member;
a belt member that is brought into contact with the rotary member, wherein a nip part through which the recording material passes is formed between the belt member and the rotary member; and
a roller member having surface elasticity, for pressing the belt member against the rotary member while stretching the belt member,
wherein the roller member includes a surface layer that reduces strain generated in its axis direction on a surface of the roller member.

10. The fixing device according to claim 9,
wherein the surface layer of the roller member reduces a difference between a strain amount of the roller member in a region through which a recording material passes and a strain amount of the roller member in regions other than the region through which a recording material passes.

11. The fixing device according to claim 9,
wherein the surface layer of the roller member is formed of a material having a higher elastic modulus than that of a rubber material.

12. The fixing device according to claim 9,
wherein the surface layer of the roller member is formed of a material having a lower Poison's ratio than that of rubber material.

13. An image forming apparatus, comprising:
a toner image forming unit that forms toner images;
a transfer unit that transfers the toner images formed by the toner image forming unit to a recording material; and
a fixing unit that fixes the toner images transferred on the recording material to the recording material,
wherein the fixing unit includes:
a rotary member;
a belt member that is brought into contact with the rotary member, wherein a nip part through which the recording material passes is formed between the belt member and the rotary member; and
a roller member that stretches the belt member and presses the belt member against the rotary member,
wherein the roller member includes an elastic layer, and a surface layer coated on a surface of the elastic layer, the surface layer being made of a material having a higher elastic modulus than that of the elastic layer.

14. The image forming apparatus according to claim 13,
wherein in the fixing unit, the surface layer of the roller member reduces a difference between a strain amount of the elastic layer in a region through which the recording material passes, and a strain amount of the elastic layer in regions other than the region through which the recording material passes.

15. The image forming apparatus according to claim 13,
wherein the surface layer of the roller member of the fixing unit is formed to a layer thickness of 15 to 150 μm.

16. The image forming apparatus according to claim 13,
wherein the surface layer of the roller member of the fixing unit is formed of fluorine resin.
